(19) United States
(12) Patent Application Publication
(10) Pub. No.: US 2024/0290155 A1
(43) Pub. Date: Aug. 29, 2024

(54) SECURED AND CONTROLLED ACCESS TO MEDIA CASSETTES

(71) Applicant: NCR Corporation, Atlanta, GA (US)

(72) Inventor: Andrew Robert Grant, Dunblane (GB)

(21) Appl. No.: 18/115,162

(22) Filed: Feb. 28, 2023

(51) Int. Cl. G07C 9/33; G07D 11/125

(52) U.S. Cl. CPC G07C 9/33; G07D 11/125; E05B 47/0002; E05B 2047/0016; G07D 2211/00

(57) ABSTRACT

Individualized locks are mounted on side walls of a cassette rack within a safe. Each lock corresponding to a cassette or rack drawer. Each lock is controlled by a safe controller to extend a pin through a side wall of the rack into a ridge, a rib, or an aperture of a guide for the cassette when a cassette is locked and to retract the pin back into the lock out of the guide when the cassette is unlocked. When the safe door is opened, each of the cassettes remained locked and the controller authorizes individual, independent, and separate unlocking of each of cassette. Audit information associated with unlocking and locking the cassettes are maintained by a cloud-based service along with information correlated for administrative operations, administrative sessions, service personnel, and terminals associated with the cassettes. A cassette-level of detail of audit information is managed by the cloud-based service.

### BACKGROUND

Terminals that accept and dispense cash include a cash depository, dispenser, and/or recycler. The depository includes a safe within which cash cassettes reside, each cassette includes a specific denomination of currency. Substantial security mechanisms are available in the industry to prevent unauthorized access to the cassettes within the safe. Yet, even when the safe is opened for authorized activities such as cash replenishment, excess cash removal, or maintenance on componentry of the safe there are still substantial risks of theft and/or to the safety of the individual performing an authorized activity.

In fact, little technology exists in the industry to secure the cassettes and monitor the cassettes during authorized service-related activities. When the safe door is opened, the cassettes are easily removed by manually unlatching the cassette and pulling the cassette out of its rack. Access to the cassette is not audited when removed from their racks; rather, the service activity that opened the safe door is monitored but each of the cassettes is not tracked and monitored separately from the activity as a whole.

Authorized individuals are trusted to perform service, but trust is not a viable security approach. A passer-by can remove cassettes easily after the safe door was opened and during an authorized service such as if the service personnel is distracted or the passer-by engages in physical violence or threats against the service personnel to obtain the cassettes. With the safe door opened, a variety of risks emerge with respect to the cash in the cassettes that did not exist when the safe door is closed. Additionally, should an individual be capable of breaching the safe or the safe door, the cassettes pose no additional impediments to the criminal for purposes of obtaining the cash.

### SUMMARY

In various embodiments, a cassette apparatus, a system, and a method are presented for securing and controlling access to media cassettes when the safe is closed and when the safe is opened. In an embodiment, a cassette apparatus includes a reinforced bottom guide situated a bottom of a cassette. The guide includes ridges, apertures, and/or ribs. An electronically controlled lock is mounted to a wall of a rack within a safe housing of the safe. The guide of the cassette slides into the rack with at least one ridge, rib, and/or aperture of the guide aligned and adjacent to the mounted lock.

A controller of the safe executes instructions to lock the cassette within the rack by extending a pin from the lock into the guide's ridge, rib, and/or aperture such that when the cassette is locked it cannot be removed from the rack. The instructions are also executed by the controller to unlock the cassette by retracting the pin out of the ridge, rib, and/or aperture. Furthermore, the instructions, executed by the controller, can also record audit information indicating when the cassette was locked and unlocked for access.

In an embodiment, when the safe door is authorized to be opened and is opened for service, the cassette remains locked in the rack and is unlocked after a separate and additional credential is provided by the service personnel. When the separate and additional credential is authenticated, the safe controller retracts the pin of the lock from the ridge, aperture, and/or rib of the cassette's guide such that cassette can be removed from the rack.

### BRIEF DESCRIPTION OF THE DRAWINGS

FIG. 1 is a diagram of a prior art cassette security apparatus within a safe body of a safe for restricting access to cassettes when the safe door is opened.

FIG. 2 is a diagram of a cassette security apparatus for restricting access to cassettes when the safe door is opened, according to an example embodiment.

FIG. 3 is a diagram of a cassette with a security guide used by the cassette security apparatus of FIG. 2, according to an example embodiment.

FIG. 4 illustrates two diagrams for two example locks used by the cassette security apparatus of FIG. 2, according to an example embodiment.

FIG. 5 is a diagram illustrating some components of a lock used by the cassette security apparatus of FIG. 2, according to an example embodiment.

FIG. 6 is a diagram illustrating locks mounted on side walls of a rack with pins of the locks extended and engaged in ribs or apertures in the guide to lock a cassette within the rack, according to an example embodiment.

FIG. 7 is a diagram illustrating a plurality of locks and cassettes that secure the cassettes to the rack of the safe body, according to an example embodiment.

FIG. 8 is a diagram of a system for securing, monitoring, and controlling access to media cassettes within a safe of a terminal, according to an example embodiment.

FIG. 9 is a flow diagram of a method for securing, monitoring, and controlling access to media cassettes within a safe of a terminal, according to an example embodiment.

### DETAILED DESCRIPTION

As stated above, it is not enough to simply securely control and audit access to a safe door when the media cassettes themselves lack any security or auditing capabilities once the safe door is opened. One approach has been attempted in the industry to plug this security hole, but it only addresses the security of the media cassettes when the safe door is opened and does not provide cassette-level auditing for the cassettes.

The prior approach is directed to steel door assemblies that are retrofitted onto the cassette rack within the safe body in front of the cassettes and behind the safe door. Once the safe door is opened, service personnel has to manually unlock the steel door to gain access to the cassettes within the rack. Installation is time consuming and requires assembling heavy steel panels. The approach also does not address terminals with dual safes. In fact, either steel door assemblies cannot be provided to dual safe terminals or require significant custom manufacturing that depends upon the dimensions and locations of the racks relative to one another within the safe. Additionally, the steel door assembly approach is an aftermarket and retrofitted technique, which provides no cassette-level auditing and tracking capabilities once the cassettes are removed. Furthermore, if service engineer removed more than one cassette at a time, there is a danger that one of the removed cassettes could just be stolen while the service engineer has attention directed away from the removed cassettes during the service call or a danger the engineer is attacked by a criminal who physically takes the removed cassettes.

These issues are solved with the teachings provided herein and below. Individualized small locks are integrated into walls of a cassette rack within a safe body of a safe. The locks when activated extend pins into apertures, ribs, or ridges of guides at the bottom of the cassettes to lock each cassette individually onto the rack. Each cassette can be associated with one or two separate locks within its racked position. For example, two opposing walls of the rack for each cassette slot can include a separate lock such that each cassette is locked on two sides to the rack.

Activation and deactivation of the locks are monitored and controlled by an existing safe controller that is enhanced to lock and unlock each of the locks via a printed circuit board (PCB) wired to the locks. In an embodiment, the PCB is daisy chained off an existing controller board for the safe and firmware/software executed by the safe controller enhanced to report events and event information associated with locking and unlocking each of the locks. The events and event information can be reported to a security or auditing service over a network connection of the terminal to provide cassette-level auditing capabilities.

The teachings provided herein do not require any steel door assemblies to secure the cassettes within the rack. Each individual cassette within the rack can be locked and unlocked independently and separately from other cassettes within the rack. This means if only one cassette in the rack requires service, the other cassettes within the rack remained locked. Additionally, should another module of the safe require service unrelated to the cassettes that module can be removed and worked on while the cassettes remained locked to the rack with the safe door opened. Furthermore, should the safe door be breached by a thief, the cassettes remained locked to the rack, which provides additional impediments experienced by the thief when attempting to acquire cash from the cassettes.

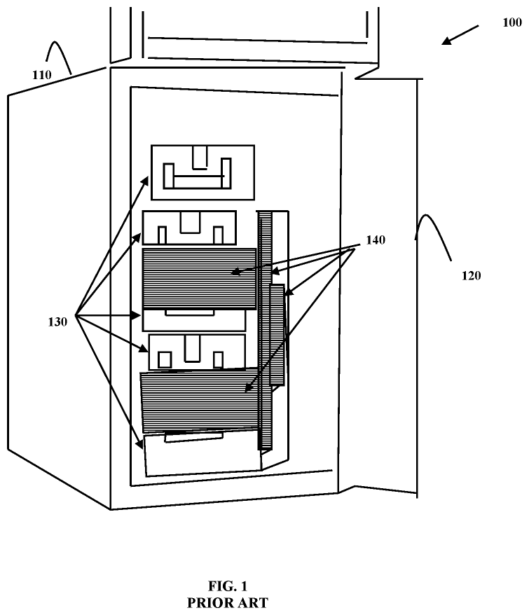

FIG. 1 is a diagram of a prior art cassette security apparatus 140 within a safe body 110 of a safe 100 for restricting access to cassettes 130 when the safe door 120 is opened. As discussed above, the security apparatus 140 includes one or more steel door assemblies, which are expensive, difficult to install, do not provide sufficient cassette security, and have no cassette-level auditing capabilities. Furthermore, the doors of the apparatus 140 are designed to cover two of the cassettes 130 at a time, such that at any given point in time at least two cassettes 130 are unlocked when a given door is unlocked by a service engineer.

As used herein, the term “cassette” refers to valuable media cassettes that store types of valuable media. The types can include cash or currency, bank notes, checks, coupons, tickets, etc. Each cassette may be associated with a specific valuable media denomination; for example, a cash denomination can have separate cassettes for $1 denominations, $5 denominations, $10 denominations, $20 denominations, $50 denominations, and $100 denominations. More than 1 cassette is stored in a cassette rack within a safe, a safe apparatus, or a safe module. The cassettes of a given cassette rack can be associated with different media types; for example, a cassette rack within a safe module of a terminal includes separate cassettes for each U.S. currency denomination and a cassette for checks.

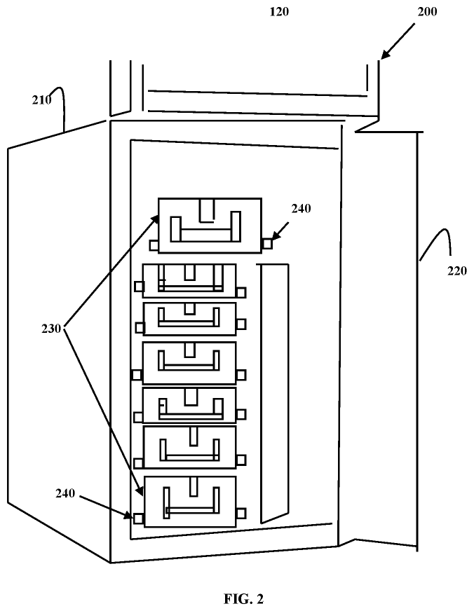

FIG. 2 is a diagram of a cassette security apparatus/safe 200 for restricting access to cassettes when the safe door 210 is opened, according to an example embodiment. A plurality of modular and individually controlled locks 230 are illustrated. Each cassette 230 includes two locks 130 on each side of the corresponding cassette 230. It is noted that in some embodiments, each cassette 230 only includes a single lock 240 on a single side of the corresponding cassette 230. The cassettes 240 are encased within a cassette rack within the safe's body 210.

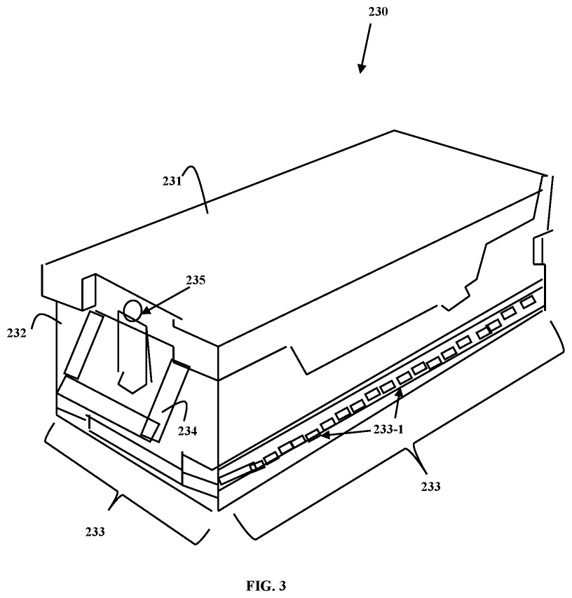

FIG. 3 is a diagram of a cassette 230 with a security guide 233 used by the cassette security apparatus 200 of FIG. 2, according to an example embodiment. The cassette 230 includes a lid or cover 231, a cassette body 232, a guide 233, a handle 234, and a latch 235. The guide 233 further includes apertures, ridges, and/or ribs 233-1 integrated into the bottom sides of the cassette 230. In an embodiment, cassette 230 is an existing cassette with its existing guide replaced by guide 233. Guide 233 is reinforced to provide structural strength in apertures 233-1.

Cassette 230 is inserted and removed from a cassette rack of the safe body 210 when service is required on the cassette 230. Guide 233 allows cassette 230 to slide into and out of its rack drawer or racked position. Apertures 233-1 permit a pin from a lock 240 to be inserted and withdrawn by lock 240. When the pin is inserted into an aperture 233-1 of guide 233, cassette 230 is locked within the rack and is incapable of being removed. Handle 234 is manufactured to break away from cassette body 232 when a predefined amount of force is exerted on handle 234. Thus, when cassette 230 is locked with the rack, any force above the predefined amount will cause the handle 234 to break off and prevent the cassette 230 from being removed without first unlocking the corresponding lock(s) 240.

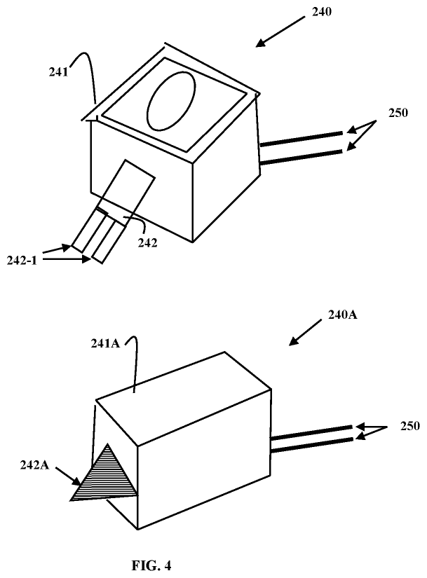

FIG. 4 illustrates two diagrams for two example locks 240 and 240A used by the cassette security apparatus 200 of FIG. 2, according to an example embodiment. Lock 240 includes a lock body 241 and a pin 242. The end of pin 242-1 is forked shaped, which permits pin 242 to be inserted between a single ridge/rib 233-1 in guide 233 to lock the cassette 230 on the cassette rack within safe body 210.

Lock 240A includes lock body 241A and a triangular shaped pin 242A. The base of 242A can be extended between two ridges or ridges 233-1 within an aperture in guide 233 to lock the cassette 230 on the cassette rack within safe body 210.

Both locks 240 and 240A are wired to a PCB via electrical wires 250. The PCB can be daisy chained off the controller board associated with the safe 200.

In an embodiment, locks 240 and 240A are solenoids. In an embodiment, pins 242 and 242A are steel pins with a diameter of 6 mm. The solenoids are controlled by signals provided over wires 250 to retract pins 240 and 240A back into lock bodies 241 and 241A when cassettes 230 are unlocked from the rack to provide unobstructed clearance for the guides 233 to slide out of their rack drawers/positions. The solenoids are also controlled by signals provided over wires 250 to extend pins 242 and 242A out from lock bodies 241 and 241A and into or in between ribs, ridges, or apertures 233-1 of guides 233 when cassettes 230 are locked into the rack to prevent cassettes 230 from being removed from their racked positions within the rack.

The locks 240 and 240A are mounted and secured to walls of the cassette rack. If necessary, holes are drilled in the sides of the walls to accommodate the pins 242 and 242A when they are being extended for locking and being retracted for unlocking. The pins 242 and 242A are aligned and positioned along the sides of the walls of the rack so as to lock and unlock via the ridges, ribs, or apertures 233-1 which are associated with back edges of the cassettes 230. That is, the locks 240 and 240A are mounted and secured to the rack walls at locations along the rack sides that correspond to backends of the cassettes 230, the front ends associated with the handles 234 are opposite of the backends associated with where the locks 240 and 240A are mounted on the rack walls.

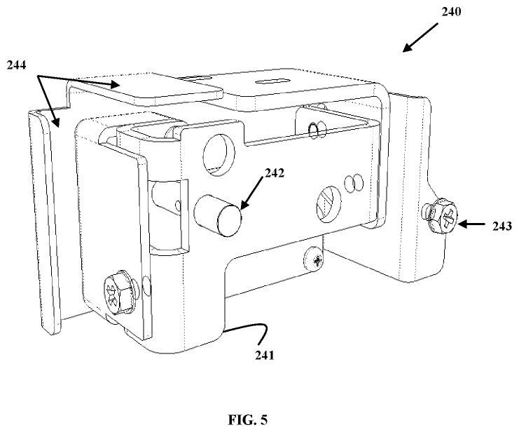

FIG. 5 is a diagram illustrating some components of a lock 240 used by the cassette security apparatus 200 of FIG. 2, according to an example embodiment. Lock 240 includes a a lock housing or body 241, a pin 242, a inside mounting screw 243, and an adjustable alignment component or tab 244. Adjustable tab 244 permits lock body 241 to be aligned properly with ridges, ribs, or apertures 233-1 after body 241 is mounted to the rack side wall. That is, pin 242 can be moved left, right, up, and down for proper alignment using tab 244.

Inside mounting screw 243 provides additional security by mounting lock body 241 on an outside surface of the rack side wall and inserting screw 243 from the inside surface of the side wall back into the aperture on lock body 241 that corresponds to screw 243. Thus, should the safe door 220 be breached and handle 234 broken off in a failed attempt to remove a cassette 230 from the rack, a thief would have to dismount the lock 240 from the inside surface of the side wall while the cassette 230 is still securely fastened to the side wall. Short of cutting the side wall itself, the cassette 230 and the lock 240 would be incapable of being removed and the cassette 230 remains locked in the rack.

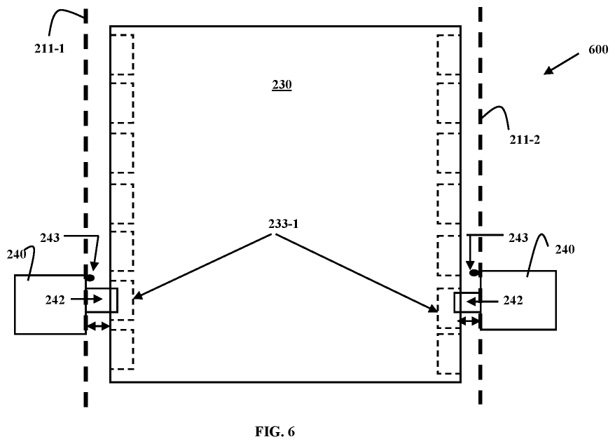

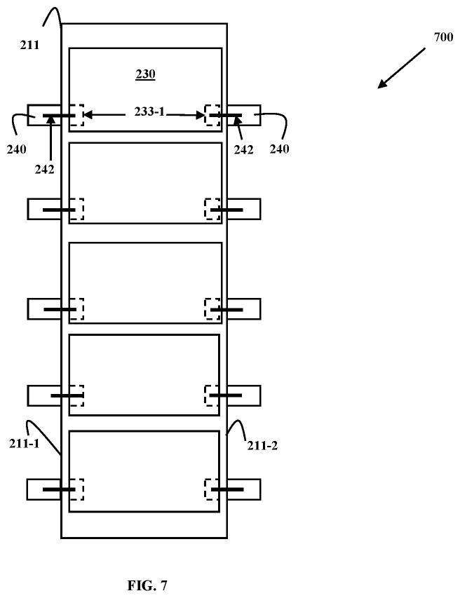

FIG. 6 is a diagram 600 illustrating locks 240 mounted on side walls 211-1 of a cassette rack 211 (shown in FIG. 7 below) with pins 242 of the locks 240 extended and engaged in ribs or apertures 233-1 in the guide 233 to lock a cassette 230 within the rack 211, according to an example embodiment.

Notice the head of screw 243 is threaded through side walls 211-1 and 211-2 from an inside surface of rack 211 into the corresponding screw hole or aperture in lock body 241. The handle end of cassette 230 is shown oriented to the top of diagram 600 with the end opposite the handle end illustrating the location and alignment of lock 240 mounted on side walls 211-1 and 211-2. Positioning lock 240 at a rear position of a racked cassette 230 makes it more difficult for a thief to access the lock 240 when the safe door 220 is opened.

FIG. 7 is a diagram 700 illustrating a plurality of locks 240 and cassettes 230 that secure the cassettes 230 to the rack 211 of the safe body 210, according to an example embodiment. The rack 211 is illustrated with 5 cassettes 230, it is noted that any configuration of less than or more than 5 cassettes 230 can be provided with the teachings herein. Additionally, diagram 700 shows that each cassette 230 includes two locks 240 on its sides when in a racked position within the rack 211. It is to be noted that a single lock 240 can secure a single cassette 230 within rack 211. Moreover, some cassettes 230 can be secured within the rack 211 by a single lock 240 while other cassettes 230 within the same rack 211 are secured by two locks 240. Still further, the individualized lock(s) 240 and architecture permits any sized rack 211 and/or dual safes with multiple cassette racks 210 to be implemented with the teachings herein. That is, there is no need to manufacture expensive customized sized steel doors or arrangement of doors to secure cassettes within their rack, since apparatus 200 can accommodate and be installed with any safe architecture using guide 233, ribs, ridges, or apertures 233-1, and locks 240.

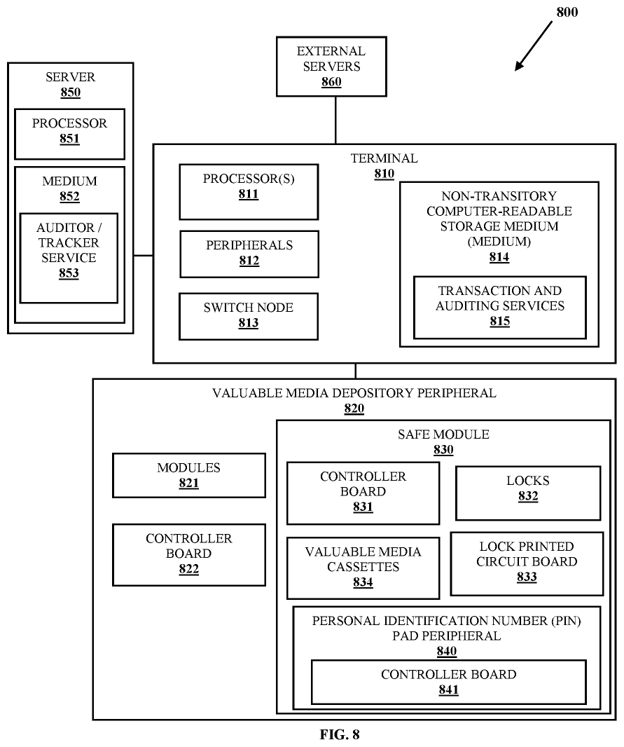

FIG. 8 is a diagram of a system 800 for securing, monitoring, and controlling access to media cassettes 230 within a depository 830 of a safe, according to an example embodiment. It is noted that system 800 is shown in greatly simplified form with only those components necessary for understanding the embodiments provided. Thus, there can be more or less components without departing from the teachings provided herein.

System 800 includes a terminal 810, a valuable media depository 820, a safe module 830, a personal identification number (PIN) pad 840, a server 850, and one or more external servers 860. Terminal 810 includes one or more processors 811, a variety of peripherals 812, a network switch node 813, and a non-transitory computer-readable storage medium (medium) 814, which includes executable instructions for transaction and auditing services 815. The instructions when executed by the processor 811 cause the processor 811 to perform operations discussed herein and below with respect to transaction and auditing services 815.

Valuable media depository peripheral (depository) 820 includes modules 821, a controller board 822, and a safe module 830. Modules 821 include a media deskew module, an upper media transport module, a lower media transport module, a media diverter module, a recycler module, a media infeed module, a media separator module, a media validation module, etc. Controller board 822 includes one or more processors and a medium, which includes software and/or firmware instructions to control and to operate modules 821, safe module 830, lock PCB 833, and PIN pad 840.

In an embodiment, lock PCB 833 is daisy chained off of controller board 831, which permits instructions processed on controller board 831 to lock and unlock locks 832 and receive events associated with locks 832 through lock PCB 833.

Safe module 830 (e.g., safe apparatus 200 described above) includes a controller board 831, one or more locks 832 (e.g., locks 240 described above), a lock PCB 833, valuable media cassettes 834 (e.g., cassettes 230), and an integrated PIN pad peripheral 841. PIN pad 841 includes a controller board 841 to operate and control PIN pad 841 independent of and in connection with safe module 830. For example, PIN pad 841 can be an encrypted PIN pad 841, which encrypts, and decrypts entered PIN data and provides a unique hash value, the hash value is incapable of being decrypted by controller board 831 and is passed with a transaction being processed up to transaction and auditing services 815. Similarly, the transaction and auditing services 815 are incapable of decrypting encrypted PIN data such that the encrypted data is forwarded through switch node 813 to an external server 860 where the encrypted data can be decrypted and validated for a transaction being processed on terminal 810.

Locks 832 are mounted on side walls of cassette rack 211 inside safe body 210 within safe module 830 and wired to lock PCB 833. Lock PCB 833 is daisy chained off controller board 831. This permits instructions of controller board 831 to extend and retract pins 242 from and back into the lock bodies 241 for purposes of locking and unlocking individual cassettes 834 through ridges, ribs, or apertures 233-1 in guides 233 of cassettes 230. Additionally, events associated with locking and unlocking individual cassettes 130 are captured and forwarded to controller board 831 from lock PCB 833.

Configuration information is maintained by controller board 831 that maps lock identifiers to cassette identifiers such that specific instructions processed by controller board 831 can properly lock and unlock specific cassettes 834 within rack 211. Additionally, the identifiers permit specific events associated with specific locks 832 to be captured, recorded, and reported by instructions of controller board 831 as events and event information associated with a specific cassette 834.

In an embodiment, instructions of controller board 831 mandate that each lock 832 or a pair of locks 832 associated with a specific cassette 834 receive an inputted password or code through PIN pad 840. Either controller board 831 or controller board 841 processes an algorithm that is capable of verifying the inputted password or code with a specific transaction operation or a specific administrative session being processed on terminal 810.

For example, a time-based one-time password (TOTP) algorithm can be based on a hash associated with an operation identifier and a current date and time. The TOTP can be initially generated by auditor/tracker service 853 and a hash of its value provided by service 853 to a cell phone of a service engineer. The service engineer has already authenticated and successfully opened a safe door 220 of safe module 840 through a first authentication. Controller board 841 or controller board 831 receives the code via input on PIN pad 840 by the engineer and independently generates the hash expected using the operation identifier provided by transaction and auditing services 815. The independently generated hash is then compared against a hash performed on the inputted code by the engineer and if they match controller board 831 unlocks a specific lock 832 or pair of locks 832 associated with an authorized cassette 834 or associated with a set of authorized cassettes 834. The events and event information raised are during the authentication to perform an unlock of a cassette 834 or set of cassettes 834 are captured by controller board 831 and reported to controller board 822. Controller board 822 reports the events and event information to tracking and auditing services 815, and services 815 provide to the auditor/tracking service 835. Service 853 records the event and event information in an audit trail associated with terminal 810, depository 820, safe module 830, PIN pad 840, the corresponding locks 832, the corresponding cassettes 834, correlated with an identifier for the administrative session, which initiated the request by the engineer to perform the cassette unlocking, and correlated with a service engineer identifier for the service engineer.

It is to be noted that there are a variety of process flows for which a credential of a service engineer is authenticated before controller board 831 unlocks a cassette 834 from the rack 211. Each such process flow is capable of being processed with system 800.

For example, auditor/tracker service 853 can independently interact with a mobile device of the service engineer for purposes of granting the service engineer permission to unlock one or more cassettes 834. Once authenticated, service 853 sends a command through transaction and auditing services 815, controller board 822, and to controller board 831. In response to the command, controller board 822 unlocks the cassette(s) 834. In an embodiment, the command sent by service 853 includes an expiration time from issuance after which controller board 831 will not unlock the cassette(s) 834.

In another case, during an administrative session services 815 display a randomly generated code or Quick Response (QR) code after the service engineer has authenticated and opened the safe door 220. The service engineer scans the code and is redirected to service 853 via a browser and given a code to enter on the Pin pad 840. The code is only valid for a defined period of time after provided by service 853.

In an embodiment, the QR code authorizing access is sent from service 853 to a mobile device of the service engineer. The engineer displays the QR code to a scanner peripheral 821 or a camera peripheral 821 of terminal 810. Services 815 decode the QR code and send the authorization down to controller board 831. In an embodiment, the QR code has a time limit after which the QR code is no longer valid for use.

Event and event information can be stored and correlated by auditor/tracker service 853 from information collected in connection with a lock event from controller board 831, controller board 822, and transaction and auditing services 815. Identifiers for the service engineer, the terminal 810, the depository 820, an administrative session between the engineer and services 815, locks 832, cassettes 834, etc. In this way, a safe door open event and be correlated with specific cassettes 834 which were unlocked during an administrative session by an engineer.

In an embodiment, terminal 820 is an automated teller machine (ATM), a self-service terminal (SST), a point-of-sale (POS) terminal, or a kiosk that accepts and distributes valuable media. In an embodiment, depository 830 is a valuable media dispenser, a valuable media deposit device, a combined dispenser and deposit device, or a valuable media recycler.

In an embodiment, controller of controller board 831 is able to receive an override code or instruction received from PIN pad 840 or service 853 to force all locks 832 to unlock. This may be useful when other instructions become corrupted and authorized service personnel are unable with other authentication techniques to cause the locks 832 to unlock the cassettes 834 from the rack drawers of the rack 211.

In an embodiment, controller board 831, locks 832, and PIN pad 840 include their own independent battery backup power. This ensures that the cassettes can be unlocked from the rack drawers during a power outage with proper authentication or with a proper override code.

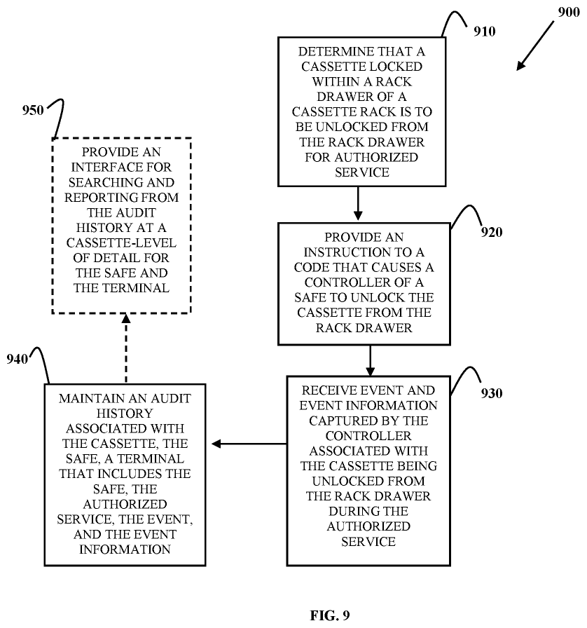

FIG. 9 is a flow diagram of a method 900 for securing, monitoring, and controlling access to media cassettes 230 and 840 within a safe 200 and 830 of a terminal 810, according to an example embodiment. The method is implemented as one or more software modules referred to herein and below as an “auditor/tracker service.” The executable instructions for the auditor/tracker service are executed by one or more processors of a device causing the processor to perform operations of the method 900 as discussed below. The auditor/tracker service has access to one or more networks during operation and the networks can be wired, wireless, or a combination of wired and wireless.

In an embodiment, the device that executes the auditor/tracker service is server 850. In an embodiment, the devices that executes the auditor/tracker service is a collection of servers operating as a cloud. In an embodiment, the auditor/tracker service is auditor/tracker service 853.

At 910, the auditor/tracker service determines that a cassette 230 locked within a rack drawer of a cassette rack 211 is to be unlocked from the rack drawer for an authorized service. This can be done in any of the manners discussed above. Moreover, this occurs only after a safe door 220 for a safe 200 is opened and the authorized service initiated. When the safe door 220 is closed, the cassette 230 remains locked to the rack drawer via one or two (a pair) of locks 240.

At 920, the auditor/tracker service provides an instruction or a code that causes a controller 831 of a safe 200 or 830 to unlock the cassette 230 or 834 from the rack drawer. That is, a secure instruction can be sent through terminal 810 to controller 831 to cause unlocking of the cassette 230 or 834; or an authentication code can be provided to a service engineer associated with the authorized service or sent to terminal 810 as was described above.

At 930, the auditor/tracker service receive event and event information captured by the controller 831. The event and event information is associated with the cassette being unlocked from the rack drawer during the authorized service. The event information can include identifiers for the devices and individuals involved in the authorized service, a current date, a current time of day, and an elapsed time that the cassette was unlocked before being re-racked and locked within the cassette rack.

At 940, the auditor/tracker service maintains an audit history associated with the cassette 230 or 834, the safe 200 or 830, the terminal 810, the authorized service, the event, and the event information. The auditor/tracker service maintains the audit history for the devices, the personnel, the cassette 230 or 834, and other cassettes unlocked for the safe 200 or 830.

In an embodiment, at 950, the auditor/tracker service provides an interface for searching and reporting from the audit history at a cassette-level of detail for the safe 200 or 830 and the terminal 810. In an embodiment, the interface is a user interface of auditor/tracker service 853.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A safe cassette apparatus, comprising:
a safe door;
a cassette rack located on an inside of a safe body and accessible when the safe door is opened;
a cassette comprising a cassette body and a cassette guide;
the cassette guide comprising ribs, ridges, or apertures located on bottom sides of the cassette guide;
a lock comprising a pin that extends from a lock body when the lock is locked and that retracts back into the lock body when the lock is unlocked;
the lock mounted on a first side wall of the cassette rack and aligned with at least one rib, ridge, or aperture on a first bottom side of the guide when the cassette is racked within the cassette rack; and
a controller configured to determine when the lock is to unlock the cassette from the cassette rack and lock the cassette to the cassette rack, unlock and lock the cassette from and to the cassette rack by controlling the pin of the lock, and capture and report events and event information associated with the cassette being locked and unlocked from the cassette rack.

2. The safe cassette apparatus of claim 1 further comprising, a second lock mounted on a second side wall of the cassette rack and aligned with at least one other rib, ridge, or aperture on a second bottom side of the guide when the cassette is racked within the cassette rack.

3. The safe cassette apparatus of claim 2, wherein the lock and the second lock are mounted in locations on the first and second side walls that correspond to a back portion of cassette when the cassette is racked within the cassette rack, the back portion opposite a handle portion of the cassette.

4. The safe cassette apparatus of claim 1, wherein the lock is a solenoid wired to a printed circuit board (PCB).

5. The safe cassette apparatus of claim 4, wherein the PCB is daisy chained off a controller board associated with the controller.

6. The safe cassette apparatus of claim 1, wherein the lock further includes a mounting screw adapted to attach the lock to the first side wall from an inside surface of the first side wall with the lock body positioned on an outside surface of the first side wall.

7. The safe cassette apparatus of claim 6, wherein the an adjustable tab adapted to adjust the location of the pin after the lock is mounted to the first side wall using the mounting screw to align the pin with the at least one rib, ridge, or aperture.

8. The safe cassette apparatus of claim 1, wherein the cassette is associated with a first rack drawer within the rack, wherein the safe cassette apparatus further includes two or more additional locks mounted on the first side wall and aligned with two or more additional cassettes associated with tow or more additional rack drawers within the rack.

9. The safe cassette apparatus of claim 1, the controller is further configured to perform authentication or ensure authentication was performed on a user that requests the cassette be unlocked from the rack.

10. The safe cassette apparatus of claim 9, wherein controller is further configured to receive a credential from the user, wherein the credential is inputted by the user though an integrated personal identification number (PIN) pad of the safe cassette apparatus when authentication is performed by the controller.

11. A system, comprising:
a transaction terminal; and
a depository comprising a safe module;
the safe module comprising:
a cassette rack adapted to hold cassettes in rack drawers, each cassette associated with a denomination of cash or deposited checks;
each cassette comprising a guide long a bottom of the corresponding cassette adapted to slide the corresponding cassette in and out of the corresponding rack drawer
each guide comprising ribs, ridges, or apertures along a first side and a second side of the corresponding guide;
pairs of locks, each lock of a given pair of locks mounted on a side wall in a location that corresponds to a back portion of a corresponding cassette when the corresponding cassette is racked in the corresponding rack drawer, wherein a first lock in the given pair of locks mounted on a first side wall of the cassette rack that corresponds to and aligns with the first side of the corresponding guide and wherein a second lock in the given pair of locks mounted on a second side wall of the cassette rack that corresponds to and aligns with the second side of the corresponding guide;
a controller configured to individually and separately control the pairs of locks for the rack drawers by activating pins of the locks to extend into the corresponding ribs, ridges, or apertures when locking the cassettes to the rack drawers and by retracting the pins out of the corresponding ribs, ridges, or apertures when unlocking the cassettes from the rack drawers.

12. The system of claim 11, wherein the controller is further configured to ensure each of the cassettes are locked to their corresponding rack drawer when a safe door for the safe module is opened and when the safe door is closed.

13. The system of claim 11, wherein the controller is further configured to process authentication on a request to unlock a given pair of locks for a given cassette before unlocking the given pair of locks.

14. The system of claim 13, wherein the controller is further configured to receive a credential inputted by a user for processing the authentication from a personal identification number (PIN) pad of the safe module.

15. The system of claim 11, wherein the controller is further configured to unlock a given pair of locks or a combination of pairs of locks when an authorized instruction to unlock the corresponding cassettes is received from the terminal.

16. The system of claim 11, wherein the controller is further configured to capture and report events and event information associated with unlocking and locking the cassettes to the rack drawers to the terminal.

17. The system of claim 11, wherein the depository is a dispenser, a deposit device, a combined dispenser and deposit device, or a recycler.

18. The system of claim 17, wherein terminal is an automated teller machine (ATM), a self-service terminal (SST), or a point-of-sale (POS) terminal.

19. A method, comprising:
determining that a cassette locked within a rack drawer of a cassette rack is to be unlocked from the rack drawer for authorized service;
providing an instruction or a code that causes a controller of a safe to unlock the cassette from the rack drawer;
receiving event and event information captured by the controller, wherein the event and the event information are associated with the cassette being unlocked from the rack drawer during the authorized service; and
maintaining an audit history associated with the cassette, the safe, a terminal that includes the safe, the authorized service, the event, and the event information.

20. The method of claim 19 further comprising, providing an interface for searching and reporting from the audit history at a cassette-level of detail for the safe and the terminal.
